(19) United States
(12) Patent Application Publication
(10) Pub. No.: US 2012/0131789 A1
(43) Pub. Date: May 31, 2012

(54) INSTALLING METHOD FOR ANCHOR CAGE AND INSTALLING METHOD FOR INDUSTRIAL EQUIPMENT

(75) Inventor: Hongbing ZHU, Beijing (CN)

(73) Assignee: SINOVEL WIND GROUP CO., LTD., Beijing (CN)

(21) Appl. No.: 13/304,209

(22) Filed: Nov. 23, 2011

(30) Foreign Application Priority Data
Nov. 25, 2010 (CN) 201010565452.6

(51) Int. Cl. B23P 11/00

(52) U.S. Cl. 29/525.11

(57) ABSTRACT

An installing method for an anchor cage and a method for installing industrial equipment includes: providing an anchor flange; providing a template flange; providing a shimming flange; assembling and fixing lower ends of part of anchor bolts in a first group of bolt holes of the anchor flange; assembling upper ends of the part of anchor bolts in a first group of bolt holes of the template flange correspondingly; adjusting and fixing all the anchor bolts after the rest anchor bolts penetrate through a second group of bolt holes of the anchor flange and a second group of bolt holes of the template flange; binding reinforcing steel bars and pouring concrete below the template flange to form a reinforced concrete platform; and taking the template flange down and assembling the upper ends of all the anchor bolts in the plurality of bolt holes of the shimming flange correspondingly.

### CROSS-REFERENCE TO RELATED APPLICATIONS

This application claims priority to Chinese Patent Application No. 201010565452.6, filed on Nov. 25, 2010, entitled “Installing method for anchor cage and installing method for industrial equipment”, which is hereby incorporated by reference in its entirety.

### FIELD OF THE TECHNOLOGY

The present invention relates to an anchor bolt installing technology, in particular to an installing method for an anchor cage and a method for installing an industrial equipment.

### BACKGROUND

In the installation of large-sized industrial equipment, the equipment is usually fixed with a foundation connection through an embedded structural piece in foundation concrete. The anchor cage is a common embedded structural form for installing the large-sized industrial equipment.

The existing anchor cage generally comprises such structural pieces as an anchor flange, a shimming flange, anchor bolts and the like, wherein the same number of bolt holes for installing the anchor bolts are respectively and uniformly distributed on the ring-shaped circumferences of the anchor flange and the shimming flange. Usually a template flange for assisting in installation is also used in the installation of the anchor cage, and the same number of bolt holes as that of the bolt holes of the anchor flange and the shimming flange are also uniformly distributed on the ring-shaped circumference of the template flange. When the concrete is poured, the anchor bolts are fixed jointly by the template flange and the anchor flange. The general installing process of the anchor cage is as follows: the anchor flange is fixed on the bottom surface of the foundation; the lower ends of the anchor bolts in the number corresponding to that of the bolt holes of the anchor flange are respectively assembled and fixed in the bolt holes of the anchor flange; the template flange is kept horizontal as far as possible after being hoisted in place, so that the upper end of each anchor bolt penetrates through the corresponding bolt hole of the template flange in the descending process; after the verticality of each anchor bolt is adjusted, the anchor bolts are fixed jointly by the template flange and the anchor flange; the concrete is poured below the template flange to form a concrete platform; the template flange is taken down after the concrete platform reaches the designed intensity, and then the shimming flange is hoisted and fixed at the upper ends of the anchor bolts to form the firm anchor cage. Under some circumstances with lower requirement for the installing precision, the shimming flange can be directly hoisted and kept horizontal as far as possible instead of adopting the template flange to adjust the verticality, and the concrete is poured below the shimming flange after the upper end of each anchor bolt penetrates through and is fixed in the corresponding bolt hole of the shimming flange in the descending process so as to finally form the firm anchor cage.

Along with the development of large size of the industrial equipment, the number of the anchor bolts embedded in the anchor cage becomes larger and larger. Accordingly, the difficulty for adopting the above prior art to install the anchor cage becomes higher and higher.

### SUMMARY

One aspect of the present invention provides an installing method for an anchor cage, which is used for lowering the installing difficulty of the anchor cage and improving the installing precision of the anchor cage at the same time.

Another aspect of the present invention provides an installing method for an anchor cage, which includes the following steps: providing an anchor flange, wherein a plurality of first bolt holes are dispersedly arranged on the anchor flange along a circumferential direction thereof, and said first bolt holes comprise a first group of bolt holes and a second group of bolt holes;

providing a template flange, wherein a plurality of bolt holes are arranged on the template flange along a circumferential direction thereof, said plurality of bolt holes comprise a first group of bolt holes and a second group of bolt holes, the first group of bolt holes of the template flange correspond to the first group of bolt holes of the anchor flange, and the second group of bolt holes of the template flange correspond to the second group of bolt holes of the anchor flange;

providing a shimming flange, wherein a plurality of bolt holes are arranged on the shimming flange along a circumferential direction thereof, and said bolt holes correspond to the first and second groups of bolt holes of said anchor flange;

assembling and fixing lower ends of part of anchor bolts in the first group of bolt holes of the anchor flange;

assembling upper ends of said part of anchor bolts in the first group of bolt holes of the template flange correspondingly;

adjusting and fixing all the anchor bolts after the rest anchor bolts penetrate through the second group of bolt holes of said anchor flange and the second group of bolt holes of said template flange;

binding reinforcing steel bars and pouring concrete below said template flange to form a reinforced concrete platform; and

taking the template flange down and assembling the upper ends of all the anchor bolts in the plurality of bolt holes of said shimming flange correspondingly.

Still another aspect of the present invention also provides a method for installing an industrial equipment, which includes the above installing method for the anchor cage and a step of installing said industrial equipment on said anchor cage.

According to the above technical solution, the anchor bolts are installed in twice, namely, part of anchor bolts for supporting and positioning are first installed and then the rest anchor bolts are installed after the template flange is well installed, so as to lower the difficulty of installing the template flange, the shimming flange and the anchor bolts and not damage threads of the anchor bolts at the same time, thereby improving the installing precision of the anchor cage.

### BRIEF DESCRIPTION OF THE DRAWINGS

In order to describe the embodiments of the present invention or the technical solution in the prior art more clearly, drawings needed for describing the embodiments or the prior art will be introduced in brief hereinafter. Obviously, what are described in the following drawings are only some embodiments of the present invention and the ordinary skill in the art can obtain other embodiments according to the drawings without any creative work.

FIG. 1 is a flow diagram describing Embodiment 1 of an installing method for an anchor cage in the present invention;

FIG. 2 is a structural diagram for an anchor flange in Embodiment 1 of the installing method for the anchor cage in the present invention;

FIG. 3 is a partial schematic diagram for an installing structure of the anchor flange in Embodiment 1 of the installing method for the anchor cage in the present invention;

FIG. 4 is a structural diagram for a template flange in Embodiment 1 of the installing method for the anchor cage in the present invention;

FIG. 5 is a partial schematic diagram for an installing structure of the template flange in Embodiment 1 of the installing method for the anchor cage in the present invention;

FIG. 6 is a partial schematic diagram for an installing structure of a shimming flange in Embodiment 1 of the installing method for the anchor cage in the present invention;

FIG. 7 is a structural diagram for the shimming flange in Embodiment 1 of the installing method for the anchor cage in the present invention;

FIG. 8 is a flow diagram describing Embodiment 2 of the installing method for the anchor cage in the present invention;

Description of main reference signs:

| | |
|---|---|
| 1—anchor flange | 2—anchor bolt |
| 3—template flange | 4—ball nut |
| 5—blinding concrete | 6—platform |
| 7—operating distance | 8—grouting groove |
| 9—shimming flange | 10—tower bottom flange |
| 11—first bolt hole | 12—second bolt hole |
| 13—first connecting plate | 14—check nut |
| 15—first bolt hole | 21—bolt sleeve |
| 22—thermal shrinkable pipe or | 31—template flange fixing frame |
| telescopic hose | |
| 32—second connecting plate | 33—fourth bolt hole |
| 61—grouting layer | 91—screw hole |
| 92—precision leveller | 93—fifth bolt hole |

### DETAILED DESCRIPTION

In order to make the purposes, technical solution and advantages of the embodiments of the present invention clearer, the technical solution in the embodiments of the present invention will be clearly and completely described hereinafter according to the drawings of the present invention. Obviously, those described here are not all but only a part of embodiments of the present invention. On the basis of the embodiments of the present invention, all other embodiments obtained by the ordinary skill in the art without any creative work should fall in the protection scope of the present invention.

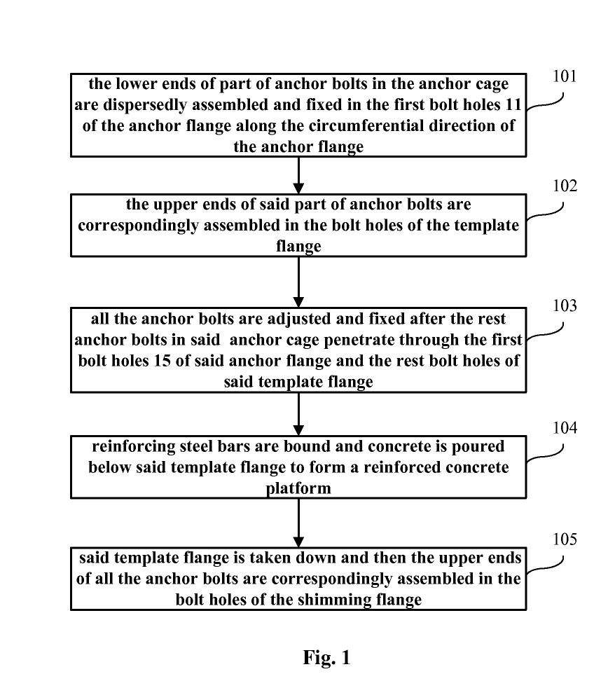

FIG. 1 is a flow diagram describing Embodiment 1 of an installing method for an anchor cage in the present invention. As shown in FIG. 1, the method of the present embodiment includes the following steps:

Step 101: the lower ends of part of anchor bolts in the anchor cage are dispersedly assembled and fixed in the first bolt holes 11 of the anchor flange along the circumferential direction of the anchor flange.

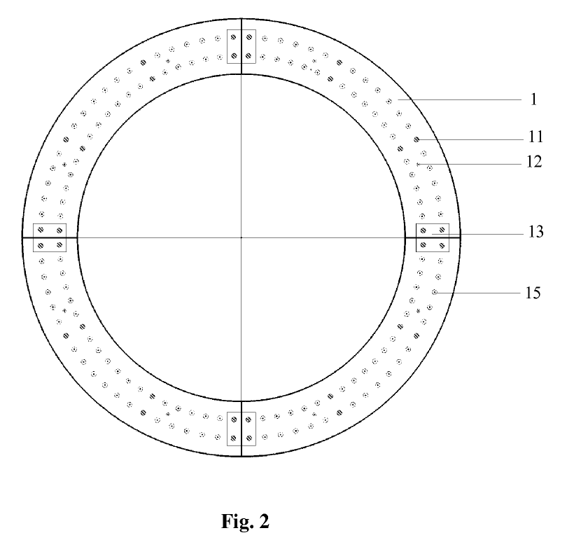

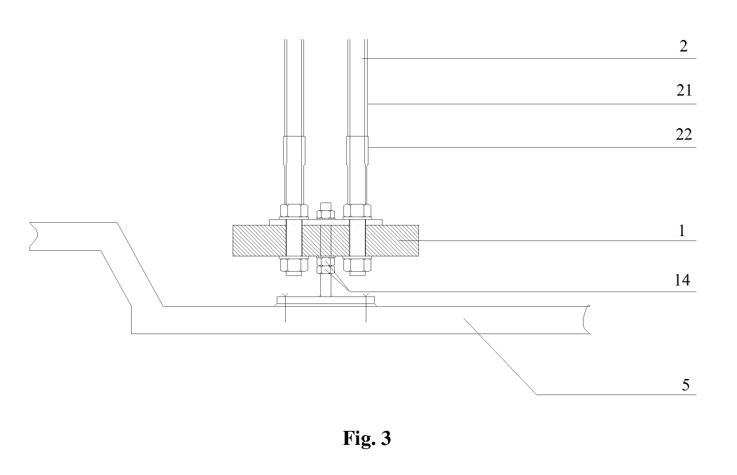

Generally speaking, a plurality of first bolt holes for assembling the anchor bolts are uniformly distributed on the anchor flange of the anchor cage in the circumferential direction, and the anchor flange can be formed through the splicing of bisected or quartered sheets or formed of an entire ring. FIG. 2 is a structural diagram for the anchor flange in Embodiment 1 of the installing method for the anchor cage in the present invention. As shown in FIG. 2, the anchor flange 1 is formed through the splicing of quartered sheets, 160 anchor bolts are installed in the embodiment, and 160 bolt holes comprising first bolt holes 11 and 15 are correspondingly distributed on the anchor flange 1. In this step, the lower ends of 32 anchor bolts are penetrate through and assembled in 32 first bolt holes 11 dispersedly on the anchor flange 1 along the circumferential direction. On one hand, a tower bottom flange of the industrial equipment to be installed and the anchor cage need to be fixed together by upper threaded segments of the anchor bolts; on the other hand, a certain operating distance for pouring concrete needs to be retained after the template flange is installed; in this case, the upper threaded segments are usually longer than lower threaded segments of the anchor bolts. The upper ends and the lower ends of the anchor bolts need to be distinguished before the assembling of the anchor bolts to avoid rework due to errors detected after the installing and fixing. FIG. 3 is a partial schematic diagram for the installing structure of the anchor flange in Embodiment 1 of an installing method for the anchor cage in the present invention. As shown in FIG. 3, in the specific operation, a bolt sleeve 21 is sheathed at the middle part of each anchor bolt 2 before the installation of the anchor bolt 2, a nut above the anchor flange 1 is screwed on the lower threaded segment of each anchor bolt 2 provided with the bolt sleeve 21, the lower threaded segment of each anchor bolt 2 is assembled in a first bolt hole 11 of the anchor flange 1, and then the nut below the anchor flange 1 is screwed down to fix each anchor bolt 2. In order to reduce grout leakage of each bolt sleeve 21, thermal shrinkable pipes or telescopic hoses 22 can be respectively sheathed at the two ends of the bolt sleeve 21, and aligned with the end surface of the nut. A screw rod segment at the middle part of each anchor bolt 2 can be separated from the foundation concrete by each bolt sleeve 21, and the tension borne by the upper part of the anchor cage can be transferred to the bottom part of a platform through the anchor bolt 2.

Step 102: the upper ends of said part of anchor bolts are correspondingly assembled in the bolt holes of the template flange.

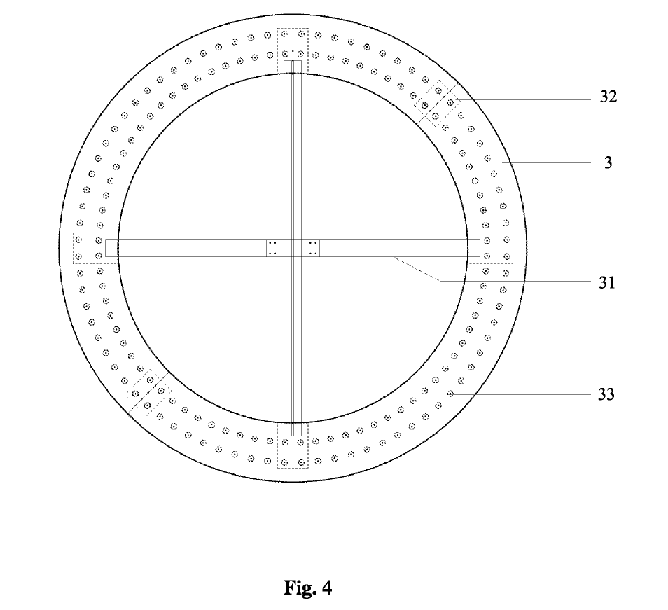

In the installing process of the anchor cage, the template flange is used for assisting in installation and accurately positioning the anchor bolts. As the template flange is used for assisting in installation only in the installing process, the thickness of the template flange can be half of that of the shimming flange, while the precision of each bolt hole on the template flange can be higher than that of each bolt hole on the shimming flange; for example, the aperture of the template flange can be smaller than that of the shimming flange; therefore, the positioning precision of the template flange to the anchor bolts is relatively higher. The template flange can be formed of an entire ring or through the splicing of two bisected template flange sheets using a connecting plate. FIG. 4 is a structural diagram for a template flange in Embodiment 1 of the installing method for the anchor cage in the present invention. As shown in FIG. 4, the ring-shaped template flange 3 is formed through the splicing of two bisected template flange sheets using a second connecting plate 32, and 160 fourth bolt holes 33 corresponding to the anchor flange 1 are also uniformly distributed on the circumference of the template flange 3. After the lower ends of 32 anchor bolts 2 are assembled and fixed on the anchor flange 1, the upper ends of the 32 anchor bolts 2 penetrate through the corresponding fourth bolt holes 33 of the template flange 3 and are fixed with the template flange 3 to support the template flange 3. As the 32 anchor bolts are relatively small in number, the installation can be finished successfully in one step under general condition. If the prior art is adopted, namely the template flange will not be installed until the installation of the 160 anchor bolts, the template flange cannot be easily installed in place in one step and threads of the anchor bolts can be seriously damaged even if the template flange is finally installed in place. Therefore, in the present embodiment, the 32 anchor bolts are installed on the template flange and this installing way is much easier to operate compared with the installing method in the prior art.

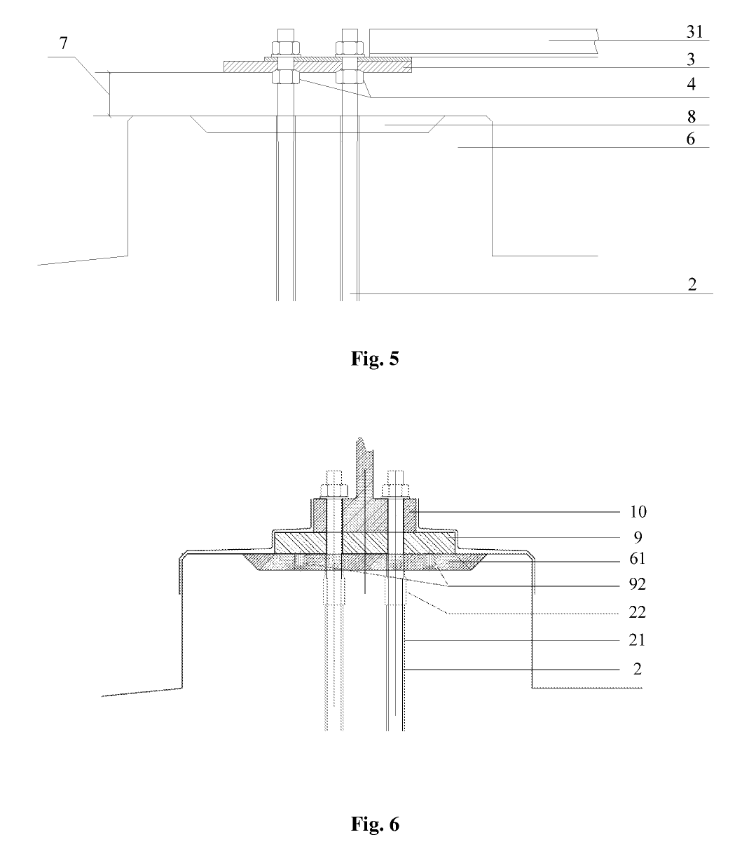

FIG. 5 is a partial schematic diagram for an installing structure of the template flange in Embodiment 1 of the installing method for the anchor cage in the present invention. As shown in FIG. 5, in the specific installing operation, a ball nut 4 is assembled on the upper threaded segment of each anchor bolt 2 and used for matching with the template flange 3 to accurately position each anchor bolt 2 and adjust the verticality of each anchor bolt 2. 32 ball nuts 4 which are respectively assembled on the upper threaded segments of the 32 anchor bolts 2 are adjusted to an installing height higher than a designed height to reserve an operating distance 7 for concrete pouring. The designed height of the anchor cage is usually equal to the height of a concrete platform 6. The template flange 3 is hoisted on the upper threaded segments of the 32 anchor bolts 2 after the ball nuts 4 are assembled, so that the upper ends of the 32 anchor bolts 2 are correspondingly assembled in the 32 fourth bolt holes 33 of the template flange, wherein the tapered opening sides of the fourth bolt holes 33 on the template flange 3 are opposite to the ball nuts 4, and the ball nuts 4 have a taper corresponding to the tapered opening sides of the fourth bolt holes 33 so as to match with the template flange 3 to adjust the verticality of the anchor bolts 2. The template flange 3 is fixed by a template flange fixing frame 31 after being installed in place. When in installation, an included angle of 45° needs to be retained between a spliced seam of the template flange and the spliced seam of the anchor flange 1 if the anchor flange 1 is also formed by means of splicing, thereby ensuring the integral stability of the anchor cage in the installing process.

Step 103: all the anchor bolts are adjusted and fixed after the rest anchor bolts in said anchor cage penetrate through the first bolt holes 15 of said anchor flange and the rest bolt holes of said template flange.

According to Step 101 and Step 102, the 32 anchor bolts which are first installed are used for supporting and positioning the template flange and the anchor flange so as to preliminarily fix the relative position of the template flange. In Step 103, all the anchor bolts are adjusted and fixed by the template flange and the anchor flange after the rest 128 anchor bolts are sequentially installed between the template flange and the anchor flange. As the 32 anchor bolts which are first installed are supported between the template flange and the anchor flange, the rest 128 anchor bolts are relatively easier to be installed. The number of the anchor bolts which are first installed is not limited to 32 and can also be other numbers (for example 24) as long as the anchor flange and the template flange can be firmly supported by the anchor bolts which are first installed.

In the specific installing operation, a ball nut 4 is also assembled on the upper threaded segment of each rest anchor bolt 2. As the rest anchor bolts 2 are assembled after the installation of the template flange 3, the bolt sleeves 21 on the rest anchor bolts 2 are sheathed on the screw rod segments at the middle parts of the anchor bolts 2 after the assembling of the ball nuts 4; in addition, the thermal shrinkable pipes or telescopic hoses 22 are respectively sheathed at the two ends of each bolt sleeve 21. When in installation, the ball nuts 4 are first screwed to the lower ends of the upper threaded segments of the anchor bolts 2, the bolt sleeves 21 are sheathed at the middle parts of the anchor bolts 2, then the nuts are screwed to the upper ends of the lower threaded segments of the anchor bolts, next, the upper threaded segments of the anchor bolts 2 penetrate through the fourth bolt holes 33 from the lower part of the template flange 3, and the lower threaded segments of the anchor bolts 2 penetrate through the corresponding first bolt holes 15 of the anchor flange 1. Then the nuts are screwed to the lower ends of the lower threaded segments of the anchor bolts 2; after the lower ends of the anchor bolts 2 are fixed, the ball nuts 4 are adjusted to the installing height; finally, each anchor bolt 2 is positioned by the template flange 3 and the corresponding ball nut 4, and fixed after the verticality is adjusted. In this step, through the matching between the template flange 3 and the corresponding ball nut 4, the verticality of each anchor bolt 2 can be accurately adjusted so that the installing precision of the anchor cage can be improved.

Step 104: reinforcing steel bars are bound and concrete is poured below said template flange to form a reinforced concrete platform.

Step 105: said template flange is taken down and then the upper ends of all the anchor bolts are correspondingly assembled in the bolt holes of the shimming flange.

FIG. 6 is a partial schematic diagram for an installing structure of a shimming flange in Embodiment 1 of the installing method for the anchor cage in the present invention. As shown in FIGS. 5 and 6, after all the anchor bolts are installed and adjusted, the reinforcing steel bars are bound and the concrete is poured below the template flange 3 to form the reinforced concrete platform 6 used for fixing the anchor cage. In the specific operation, the concrete can be poured to form the reinforced concrete platform 6 having a sunken grouting groove 8, and grouting can be carried out in the grouting groove 8 after the subsequent installation of the shimming flange 9 so as to form a high-intensity grouting layer 61. Due to the sunken grouting groove 8 of the reinforced concrete platform 6, the leakage of grouting materials caused by non-close spliced seams of a grouting layer template can be eliminated. Before the grouting materials are filled, the platform 6 needs to be completely wetted and water is filled in the reserved grouting groove 8 at the same time; in this case, foundation concrete can absorb water to become saturated, thereby ensuring the grouting quality.

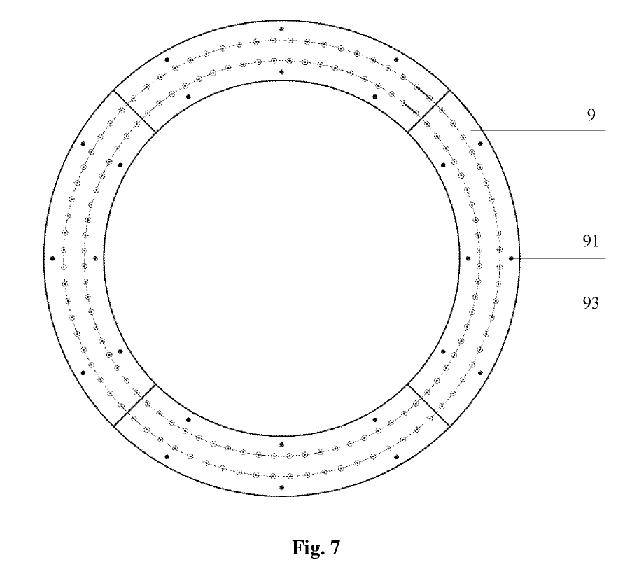

After the solidification of the foundation concrete, the template flange 3 for assisting in installation is taken down and the shimming flange 9 is assembled at the upper ends of the anchor bolts 2. The shimming flange 9 can be formed through the splicing of two or four shimming flange sheets or of an entire ring. FIG. 7 is a structural diagram for the shimming flange 9 in Embodiment 1 of the installing method for the anchor cage in the present invention. As shown in FIG. 7, the shimming flange 9 is formed through the splicing of four shimming flange sheets, and 160 fifth bolt holes 93 corresponding to the anchor flange 1 are uniformly distributed on the ring-shaped circumference of the shimming flange 9. As each anchor bolt 2 is fixed by the reinforced concrete platform 6 after being accurately positioned by the template flange 3, the shimming flange 9 can be hoisted and easily assembled on the anchor bolts 2.

Screw holes 91 for assembling a plurality of precision levellers 92 can also be arranged on the shimming flange 9, and the horizontality of the shimming flange 9 can be adjusted through the precision levellers 92 arranged in the screw holes 91. In the specific operation, the precision levellers 92 are assembled in the screw holes 91 below the shimming flange 9, the shimming flange 9 is hoisted on the upper threaded segments of all the anchor bolts 2, and the upper threaded segments of all the anchor bolts 2 are correspondingly assembled in the fifth screw holes 93 of the shimming flange 9; in addition, the precision levellers 92 are adjusted to realize that the surface of the shimming flange 9 is horizontal and the lower surface of the shimming flange 9 is located at the designed height. After the shimming flange 9 is installed, the tower bottom flange 10 of the industrial equipment to be installed and fixed can be fixed together with the anchor cage under the tower bottom flange 10 through the anchor bolts 2. If both the shimming flange 9 and the anchor flange 1 are formed through the splicing of a plurality of sheets, when the shimming flange 9 is hoisted on the upper threaded segments of the anchor bolts 2, an included angle of 45° needs to be retained between a spliced seam of the shimming flange 9 and the spliced seam of the anchor flange 1, thereby ensuring the integral stability of the anchor cage.

In the present embodiment, the anchor bolts are installed in twice, part of anchor bolts for supporting and positioning are first installed and then the rest anchor bolts are installed after the template flange is well installed, so as to lower the difficulty of installing the template flange, the shimming flange and the anchor bolts and not damage threads of the anchor bolts at the same time, thereby improving the installing precision of the anchor cage.

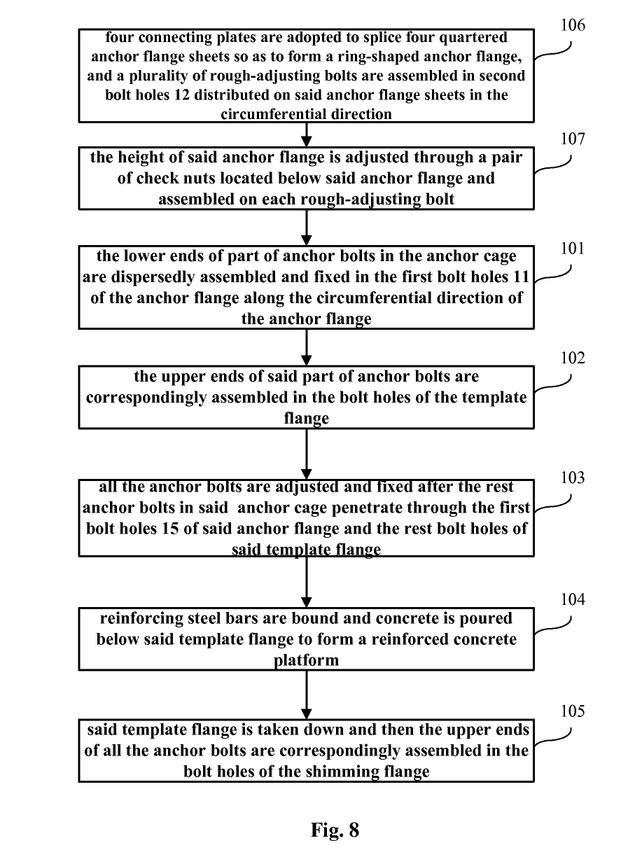

FIG. 8 is a flow diagram describing Embodiment 2 of the installing method for the anchor cage in the present invention. As shown in FIG. 8, the method in Embodiment 2 can also include the following steps before Step 101 in Embodiment 1:

Step 106: four connecting plates are adopted to splice four quartered anchor flange sheets so as to form a ring-shaped anchor flange, and a plurality of rough-adjusting bolts are assembled in second bolt holes 12 distributed on said anchor flange sheets in the circumferential direction.

Step 107: the height of said anchor flange is adjusted through a pair of check nuts located below said anchor flange and assembled on each rough-adjusting bolt.

Generally speaking, the anchor flange in the anchor cage is usually formed through the splicing of bisected or quartered sheets or formed of an entire ring. Being the same as that shown in FIGS. 2 and 3 in Embodiment 1, the anchor flange in Embodiment 2 is also formed through the splicing of quartered anchor flange sheets, every two adjacent sheets are respectively connected and fixed through a first connecting plate 13, and a second bolt hole 12 for installing each rough-adjusting bolt is distributed on each sheet. Three nuts are assembled at the two ends of each rough-adjusting bolt, wherein one nut is located above the anchor flange 1, and the other two nuts, namely a pair of check nuts 14 are located below the anchor flange 1; and the pair of check nuts 14 can be used for not only carrying out one-time leveling on the anchor flange 1 but also preventing from becoming loose due to the weight of the anchor cage. When the anchor flange 1 is fixed on a blinding concrete 5 of the foundation, the adjusting method through descending can be adopted, namely the check nuts 14 can be adjusted downwards to control the height of the anchor flange 1. Moreover, the rough-adjusting bolts in Embodiment 2 are also used for supporting the anchor flange on the blinding concrete 5 of the foundation.

After the anchor flange 1 is fixed on the blinding concrete 5 of the foundation, the method in Embodiment 1 can be adopted to carry out subsequent installing operation to finish the installation of the entire anchor cage. The subsequent installing steps will not be described here again.

Furthermore, the shapes of the anchor flange, the template flange, etc. in the present invention are not limited to ring shape but also can be square, rectangle, polygon shape, etc.

Before the installation of the anchor cage in the embodiment, some preparing work can also be carried out, such as counting the number of various components and checking whether the various components are deformed or the threads of the anchor bolts are damaged. In this case, timely treatment can be carried out if any problem is detected so as to ensure the smooth proceeding of subsequent installing work.

In the embodiment, through the rough-adjusting bolts arranged on the anchor flange and the check nuts on the rough-adjusting bolts, the anchor cage cannot easily slide downwards to become loose; meanwhile, the rough-adjusting bolts and the check nuts are also helpful for adjusting the height of the anchor flange.

The embodiment of the method for installing the industrial equipment can include the installing method for the anchor cage in any of the above embodiments and the method for installing the industrial equipment on the anchor cage. After being installed according to the above method, the anchor cage is connected and fixed with the industrial equipment above the anchor cage through the tower bottom flange. The industrial equipment can be a wind power generator and the like.

With the adoption of the method for installing the industrial equipment in the embodiment, the installing difficulty of the anchor cage in the industrial equipment can be lowered and the installing precision can be improved. The operation principle and the achieved technical effect of the method for installing the industrial equipment are the same as those of the installing method for the anchor cage. No more details will be given here again.

Finally, it should be noted that the above examples are merely provided for describing the technical solutions of the present invention, but not intended to limit the present invention. It should be understood by the ordinary skill in the art that although the present invention is described in detail with reference to the foregoing embodiments, modifications can be made to the technical solutions described in the foregoing embodiments, or equivalent replacements can be made to some technical features in the technical solutions, without the essence of corresponding technical solutions departing from the spirit and scope of the embodiments of the present invention.

What is claimed is:

1. An installing method for an anchor cage, characterized by including the following steps:
providing an anchor flange, wherein a plurality of first bolt holes are dispersedly arranged on the anchor flange along a circumferential direction thereof, and said first bolt holes comprise a first group of bolt holes and a second group of bolt holes;
providing a template flange, wherein a plurality of bolt holes are arranged on the template flange along a circumferential direction thereof, said plurality of bolt holes comprise a first group of bolt holes and a second group of bolt holes, the first group of bolt holes of the template flange correspond to the first group of bolt holes of the anchor flange, and the second group of bolt holes of the template flange correspond to second bolt holes of the anchor flange;
providing a shimming flange, wherein a plurality of bolt holes are arranged on the shimming flange along a circumferential direction thereof, and said bolt holes correspond to the first and second groups of bolt holes of said anchor flange;
assembling and fixing lower ends of part of anchor bolts in the first group of bolt holes of the anchor flange;
assembling upper ends of the part of anchor bolts in the first group of bolt holes of the template flange correspondingly;
adjusting and fixing all the anchor bolts after the rest anchor bolts penetrate through the second group of bolt holes of said anchor flange and the second group of bolt holes of said template flange;
binding reinforcing steel bars and pouring concrete below said template flange to form a reinforced concrete platform; and
taking said template flange down and assembling the upper ends of all the anchor bolts in the plurality of bolt holes of said shimming flange correspondingly.

2. The method according to claim 1, characterized by further including the following steps before assembling and fixing the lower ends of part of anchor bolts in the first group of bolt holes of the anchor flange:
splicing four quartered anchor flange sheets using four connecting plates to form the anchor flange in ring-shaped;
assembling a plurality of rough-adjusting bolts in a plurality of second bolt holes distributed on said anchor flange sheets along the circumferential direction; and
adjusting a height of said anchor flange through a pair of check nuts located below said anchor flange and assembled on each rough-adjusting bolt.

3. The method according to claim 1, characterized in that the step that assembling and fixing the lower ends of part of anchor bolts in the first group of bolt holes of the anchor flange specifically includes the following step:
sheathing a bolt sleeve at the middle part of each one of said part of anchor bolts, and assembling and fixing lower threaded segments of said part of anchor bolts sheathing with the bolt sleeves in the first group of bolt holes of said anchor flange respectively.

4. The method according to claim 1, characterized in that the step that assembling the upper ends of part of anchor bolts in the first group of bolt holes of the template flange correspondingly specifically includes the following steps:
assembling a ball nut on an upper threaded segment of each one of said part of anchor bolts and adjusting the ball nut to an installing height;
splicing two bisected template flange sheets using a connecting plate to form the template flange in ring-shaped;
hoisting said template flange on the upper threaded segments of said part of anchor bolts, and assembling the upper ends of said part of anchor bolts in the first group of bolt holes of said template flange correspondingly such that tapered opening sides of the first group of bolt holes on said template flange are opposite to said ball nuts; and
retaining an included angle of 45° between a spliced seam of said template flange and a spliced seam of said anchor flange if said anchor flange is formed by means of splicing.

5. The method according to claim 4, characterized in that the step that adjusting and fixing all the anchor bolts after the rest anchor bolts penetrate through the second group of bolt holes of said anchor flange and the second group of bolt holes of said template flange specifically includes the following steps:
first assembling a ball nut at the upper end of each one of said rest anchor bolts, and then sheathing a bolt sleeve at the middle part of each one of said rest anchor bolts;
penetrating through the second group of bolt holes of said template flange by the upper threaded segments of the rest anchor bolts, and penetrating through the second group of bolt holes of said anchor flange by the lower threaded segments of the rest anchor bolts;
adjusting the ball nuts to said installing height after the lower ends of the rest anchor bolts are fixed; and
positioning each anchor bolt and adjusting a verticality of the anchor bolt by said template flange and the corresponding ball nut, and then fixing the anchor bolt.

6. The method according to claim 1, characterized in that the step that forming a reinforced concrete platform specifically includes the following steps:
forming the reinforced concrete platform provided with a sunken grouting groove; and
carrying out grouting in said sunken grouting groove to form a grouting layer after the upper ends of all the anchor bolts are correspondingly assembled in the plurality of bolt holes of said shimming flange.

7. The method according to claim 1, characterized in that the step that assembling the upper ends of all the anchor bolts in the plurality of bolt holes of said shimming flange correspondingly specifically includes the following steps:
assembling a plurality of precision levellers in screw holes below said shimming flange, hoisting said shimming flange on the upper threaded segments of all the anchor bolts, and assembling the upper threaded segments of all the anchor bolts in the plurality of bolt holes of said shimming flange correspondingly; and
adjusting said precision levellers such that the surface of said shimming flange is horizontal and the lower surface of the shimming flange is located at a designed height.

8. The method according to claim 7, characterized in that the step that hoisting said shimming flange on the upper threaded segments of all the anchor bolts specifically includes the following step:
if said shimming flange is formed through the splicing of two or four shimming flange sheets and said anchor flange is also formed by means of splicing, an included angle of 45° is retained between a spliced seam of said shimming flange and a spliced seam of said anchor flange when said shimming flange is hoisted on the upper threaded segments of all the anchor bolts.

9. A method for installing industrial equipment, characterized by including said installing method for the anchor cage in claim 1 and a step of installing said industrial equipment on said anchor cage.

10. The method according to claim 9, characterized in that said industrial equipment is a wind power generator.
